(19) United States
(12) Patent Application Publication
(10) Pub. No.: US 2024/0082925 A1
(43) Pub. Date: Mar. 14, 2024

(54) DOORS FOR A MACHINE TOOL

(71) Applicant: Mazak Corporation, Florence, KY (US)

(72) Inventors: Seiichi Hattori, Florence, KY (US); Koichi Eboshi, Hebron, KY (US); Katsuki Sano, Ichinomiya-shi (JP)

(21) Appl. No.: 17/941,953

(22) Filed: Sep. 9, 2022

(51) Int. Cl. B23B 25/00; B23B 1/00

(52) U.S. Cl. CPC B23B 25/00; B23B 1/00

(57) ABSTRACT

In one aspect, a machine tool having a frame assembly, a first head having a first rotatable workpiece holder, and a second head having a second rotatable workpiece holder. The frame assembly includes a first door movable in a first direction between a first closed position and a first open position and a second door movable in a second direction transverse to the first direction between a second closed position and a second open position. The frame assembly has an access opening sized to permit access to the first and second heads with the first door in the first open position and the second door in the second closed position. The frame assembly has a larger access opening to increase ease of user accessibility to the first and second heads with the first door in the first open position and the second door in the second open position.

### FIELD

This disclosure relates to machine tools having enclosed machining areas and, more specifically, doors for closing a machining area of a machine tool.

### BACKGROUND

Swiss-type machine tools have a machining area including a head that rotates a workpiece around an axis and tools that are brought into contact with the rotating workpiece to machine the workpiece. The head of the Swiss-type machine tool includes a shaft assembly that is secured to the workpiece so that the workpiece extends in a cantilevered manner therefrom. A motor of the Swiss-type machine tool rotates the shaft assembly and workpiece secured thereto. The Swiss-type machine tool shifts the shaft from a retracted position to an extended position which causes corresponding axial shifting of the workpiece. The axial shifting of the workpiece shifts a portion of the workpiece into position for being machined by cutting tools of the Swiss-type machine tool. Typically, the cutting tools of the Swiss-type machine tool are provided in an array of tool holders that are shiftable in X- and Y-axes relative to the workpiece to bring tools supported by the tool holders into contact with the outer diameter of the workpiece to be machined, whereas the Z-axis motion comes from axial movement of the workpiece rather than movement of the tool holders.

Swiss-type machine tools often have an enclosure about the machining area to keep debris and machining fluids within the machine tool. The enclosure includes a door that can be opened by an operator to provide access to the head, such as for loading a workpiece into the head or removing the workpiece from the head. Similarly, an operator may open the door to load or unload tools into or out of tool holders of the Swiss-type machine tool. The enclosure has a door opening that is closed by the door. The operator may frequently be on one side of the enclosure near the head, since the operator will be loading/unloading workpieces relative to the head, loading/unloading tools relative to the tool holders near the head, and/or handling a guide bushing of the head. The operator may need to position their torso against the door frame at the side of the door opening closest to the machine tool head, while their legs remain outside the entrance, so that the operator can reach around and into the machining area in order to manually perform these tasks. As is apparent, requiring the operator to contort their body for accessing and working on the machining area, while their legs remain outside the machining area, is ergonomically undesirable.

### SUMMARY

In one aspect of the present disclosure, a machine tool is provided that includes a frame assembly, a first head having a first rotatable workpiece holder, and a second head having a second rotatable workpiece holder. The frame assembly includes a first door movable in a first direction between a first closed position and a first open position and a second door movable in a second direction transverse to the first direction between a second closed position and a second open position. The frame assembly has an access opening sized to be closed by the first door in the first closed position. Once the first door has been moved toward the first open position, the access opening is sized to permit access to the first and second heads with the first door in the first open position and the second door in the second closed position. The frame assembly has a larger access opening sized to be closed by the first door in the first closed position and the second door in the second closed position. Once the first and second doors have been moved to the first and second open positions, the larger access opening of the frame assembly increases ease of user accessibility to the first and second heads. In this manner, the second door may be opened to enlarge the access opening of the frame assembly which improves the ease with which the user may position their upper torso, e.g., arms, shoulders, etc. in the access opening of the frame assembly and access the first and second heads and other examples in the machining area.

The present disclosure also provides a machine tool having a head to rotate a workpiece and tool holders configured to receive tools for machining the workpiece. The machine tool includes a first door movable between a first closed position wherein the first door obstructs access to the head and the tool holders and a first open position wherein the first door permits access to the head and the tool holders. The machine tool further includes a second door movable between a second closed position and a second open position when the first door is in the first open position to increase access to the head and tool holders. The second door is not movable between the second closed position and the second open position when the first door is in the first closed position. For example, the first and second doors may include an interface with stop members such as flanges configured to be brought into contact and inhibit opening of the second door if an operator attempts to open the second door while the first door is in the first closed position. The user may thereby open the first door to access the head and tool holders and, if additional space is desired, the user may open the second door to increase access to the head and tool holders.

In another aspect of the present disclosure, a method is provided for operating a machine tool. The method includes opening a first door of the machine tool in a first direction to form an access opening that permits access to a head and tool holders of the machine tool. The method further includes opening a second door of the machine tool in a second direction transverse to the first direction to enlarge the access opening and increase access to the head and the tool holders. By opening the first and second doors in transverse directions, the first and second doors may be moved apart to maximize access to the head and tool holders of the machine tool.

The present disclosure further provides doors for closing a machining area of a machine tool. The doors include a first door having pivotally connected door sections and a second door. The first and second doors having a closed configuration wherein the first and second doors are closed and inhibit access to the machining area. The first and second doors have a partially open configuration wherein the first door is open and the second door is closed. The first and second doors in the partially open configuration permit access to the machining area, such as mounting or removing a workpiece from a head of the machine tool. The first and second doors further include a fully open configuration wherein the first door is open and the second door is open. In the fully open configuration, the first and second doors permit increased access to the machining area compared to when the first and second doors are in the partially open configuration.

### BRIEF DESCRIPTION OF THE DRAWINGS

FIG. 1 is a perspective view of a machine tool having a folding door that can be opened to provide an access opening to a machining area of the machine tool and a sliding door that can be opened to provide an enlarged access opening for accessing the machining area;

FIG. 2 is a perspective view of a portion of the machine tool of FIG. 1 showing the folding door in an open position and the sliding door in a closed position;

FIG. 3 is a view similar to FIG. 2 showing the sliding door moved to an open position to provide a wider opening for accessing the machining area;

FIG. 4 is a perspective view of the machining area of FIG. 1 showing portions of a first head and a second head of the machine tool;

FIG. 5A is a schematic view of the first head of FIG. 4 showing a motor, and a spindle including a spline shaft having a workpiece holder and a spindle shaft having a guide bushing;

FIG. 5B is a perspective view of tool holders in the machining area for supporting tools that are brought into contact with a workpiece held by the first head, the second head, or both;

FIG. 6 is a perspective view of the folding door of the machine tool of FIG. 1 having guide rollers that travel along tracks of the machine tool;

FIG. 7 is an enlarged view of a portion of FIG. 6 showing one of the rollers of the folding door;

FIG. 8 is a perspective view of the sliding door of FIG. 1 showing the sliding door including a section of one of the tracks of the machine tool;

FIG. 9 is a cross-sectional view of an interface between the sliding door and the folding door of the machine tool showing overlapping flanges of the doors that inhibit opening of the sliding door when the folding door is closed; and

FIG. 10 is a cross-sectional view of a slide connection between the sliding door and a frame member of the machine tool.

### DETAILED DESCRIPTION

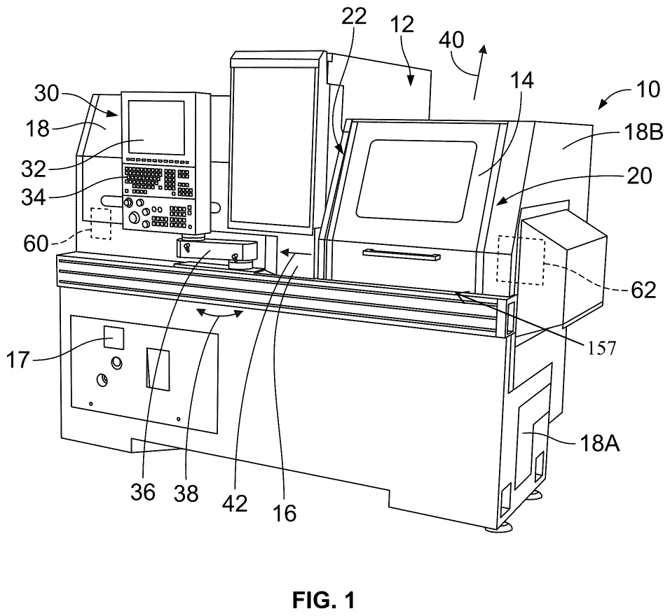

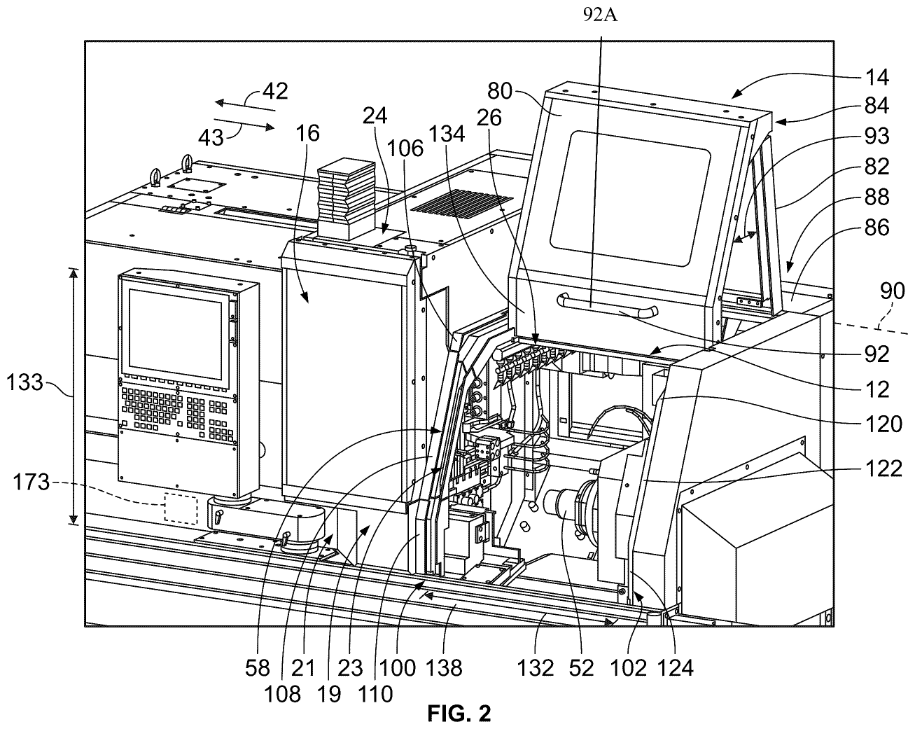

With reference to FIG. 1, a machine tool 10 is shown having a machining area 12 and a frame assembly 18 extending about the machining area 12. The frame assembly 18 includes a base 18A, frame members such as rails for movably supporting components of the machine tool 10, and an enclosure or housing 18B for the machining area 12. The frame assembly 18 includes a first door such as folding door 14 and a second door such as sliding door 16 that are each movable between closed and open positions to control access to the machining area 12 and close the machining area 12 during machining operations. The frame assembly 18 has a first door frame 20 that forms an interface 22 with the folding door 14 such that when the door 14 is closed, machining debris and fluid sprayed from a machining liquid supply 26 (see FIG. 2) onto a workpiece during machining is kept from exiting the machining area 12. The frame assembly 18 likewise has a guide, such a door frame 21, that forms an interface 24 with the sliding door 16 so that when the door 16 is closed, egress of machining debris and liquid from the machining area 12 is limited.

With reference to FIGS. 1-3, the folding door 14 is movable generally upward and rearward in direction 40 from a closed position shown in FIG. 1 to an open position shown in FIG. 2. The first door frame 20 of the frame assembly 18 has frame members 20A, including door guide tracks as discussed further hereafter, that extend about an access opening 23 such that when the folding door 14 is in the open position, an operator has access to the machining area 12. The folding door 14 has door portions, such as door panels or door sections 80, 82, pivotally connected by a hinge 84. The hinge 84 permits the door sections 80, 82 to pivot relative to one another as the folding door 14 is moved in direction 40 toward the open position. In one embodiment, the hinge 84 includes knuckles of the door sections 80, 82 and pins extending through openings of the knuckles to pivotally connect the door sections 80, 82. Because the door sections 80, 82 move upward and over the machining area 12, any liquid on an interior side 85 of the door sections 80, 82 facing the machining area 12 can fall into and be collected in the machining area 12 rather than falling outside of the machine tool 10 such as on the factory floor.

The door section 82 is connected to an upper portion 86 of the frame assembly 18 via a hinge 88. The hinge 88 includes a first hinge leaf fixed to the door section 82, a second hinge leaf fixed to the frame assembly upper portion 86, and a pin extending through knuckles of the first and second hinge leaves to pivotally connect the first and second hinge leaves. The hinge 88 permits the door section 82 to pivot about a stationary axis 90 as a human operator lifts upward on a handle 92 (see FIG. 2) of the folding door 14 to move the folding door 14 to the open position thereof. The door section 82 is constrained to pivotal movement about the stationary axis 90 whereas the door section 80 moves toward or away from the door section 82 during opening and closing of the folding door 14. The handle 92 has an elongate horizontal, gripping portion 92A that permits the operator to lift upwardly on the handle 92 and drive the door section 80 open the folding door 14. Moving the folding door 14 to the open position decreases an angle 93 between the door sections 80, 82.

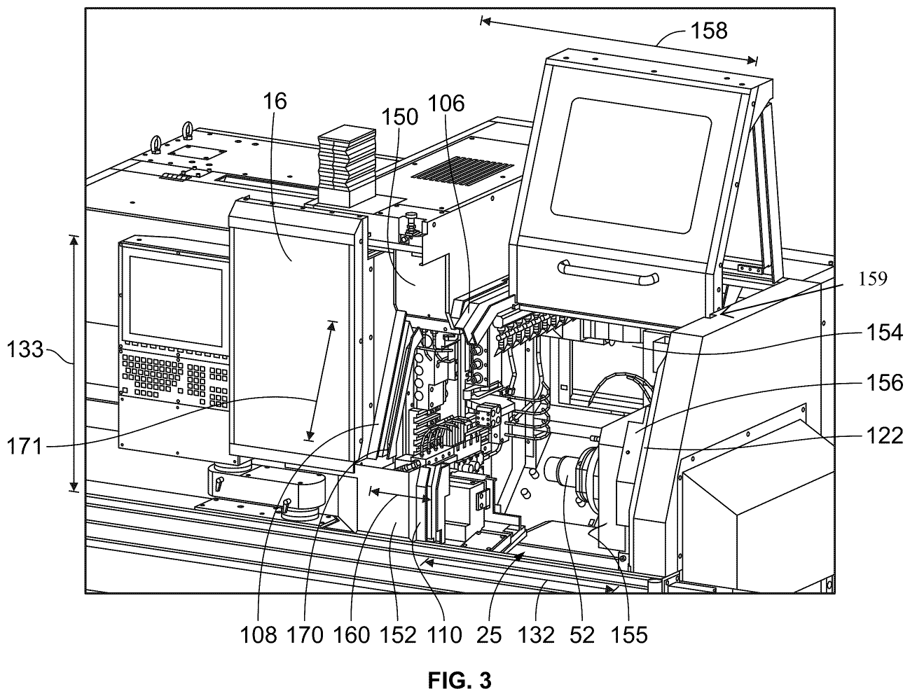

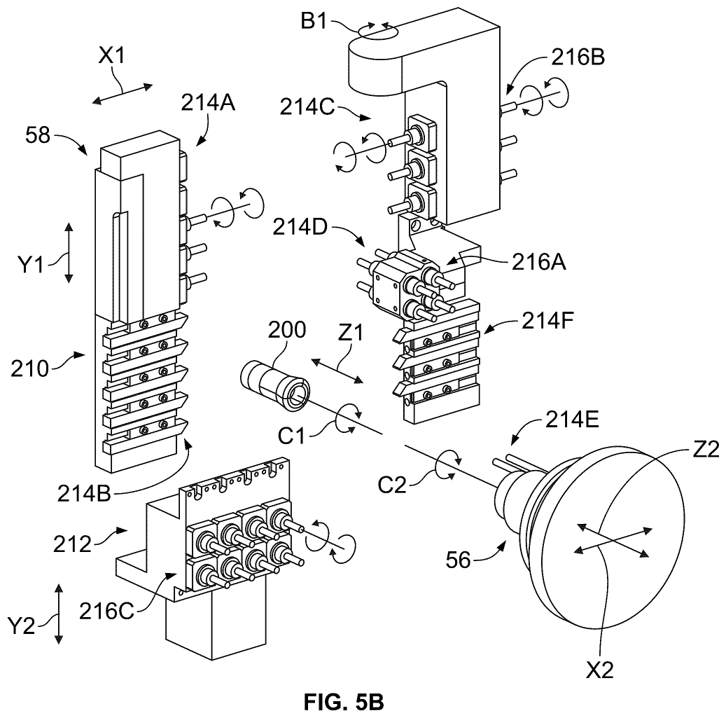

The sliding door 16 is movable from a closed position shown in FIG. 1 to an open position shown in FIG. 3. The sliding door 16 moves in direction 42 transverse to the direction 40 of movement of the folding door as the sliding door 16 moves from the closed position of FIG. 2 to the open position of FIG. 3. The sliding door 16, when closed, covers an opening bounded by upper and lower support frames 150, 152 and the side member 240 (see FIG. 6) of the door section 80.

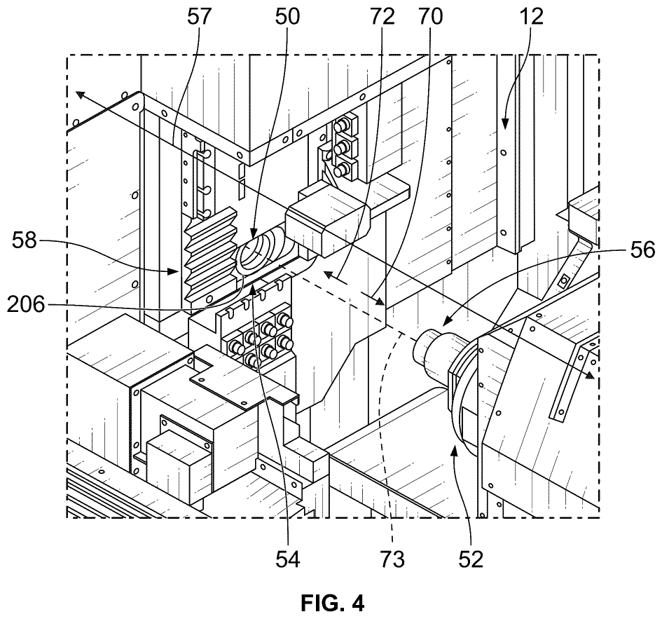

Thus, with both the folding door 14 and the sliding door 16 in the open positions thereof, the frame assembly 18 has an enlarged access opening 25 larger than the access opening 23. The enlarged access opening 25 provides additional clearance for an operator to access a first head 50 (see FIG. 4) and a tool holder system 58 of the machine tool 10. With reference to FIG. 4, the machining area 12 has an internal width 57 across the machining area 12 and the sliding door 16 covers or extends along less of the internal width 57 when the sliding door 16 is in the open position than when the sliding door 16 is in the closed position. This allows the operator to position their upper torso closer to the first head 50 so they do not have to reach as far into the machining area 12 as they would otherwise have to do.

The tool holder system 58 includes one or more tool holders to support and advance one or more tools, such as turning tools, boring tools, etc., into and out of cutting engagement with the workpiece received in the first head 50 (see FIG. 2) and/or a second head 52 of the machine tool 10. The first head 50 and tool holder system 58 are components of the machine tool 10 that are frequently accessed by an operator, such as for loading and unloading workpieces and tools. Providing an enlarged opening can provide improved ergonomics for a user by permitting the user to be closer to the components and have an optimal posture for applying leverage when operating a tool such as while turning a wrench to secure a tool in one of the tool holders of the tool holder system 58.

With reference to FIG. 1, the machine tool 10 has a user interface 30 to provide information to a controller 17 of the machine tool 10. The operator may provide information such as workpiece dimensions, tool identifiers, programming, tolerances, or other variables as utilized for a particular machining operation. The user interface 30 may include a screen 32 and a keyboard 34, as some examples. The machine tool 10 has a user interface support, such as an arm 36, that is pivotal in direction 38 to permit a user to adjust a position of the user interface 30 relative to the frame assembly 18 including the sliding door 16. The user interface 30 is accessible when the sliding door 16 is in the closed position (see FIG. 1) and when the sliding door 16 is in the open position (see FIG. 3), even when the arm 36 is pivoted toward a retracted position adjacent a front side 18C of the frame assembly 18. The machine tool 10 may include communication circuitry such as a WiFi, ethernet, and/or Bluetooth® interface that permit the controller 17 to receive information from a remote device such as a laptop computer, a tablet computer, and/or a smartphone.

With reference to FIG. 4, the first and second heads 50, 52 include first and second spindles 54, 56 that are rotatable to rotate workpieces held therein around an axis 73 as the workpieces are machined by tools of the tool holder system 58. The first and second spindles 54, 56 include workpiece holders (e.g., collets) for securing workpieces in the first and second spindles 54, 56. The first head 50 includes a first drive 60 (see FIG. 1) such as an electric motor for rotating the first spindle 54. The second head 52 likewise includes a second drive 62 (see FIG. 1) such as an electric motor for rotating the second spindle 56. The first and second drives 60, 62 are operable to rotate the first and second spindles 54, 56 independently of one another.

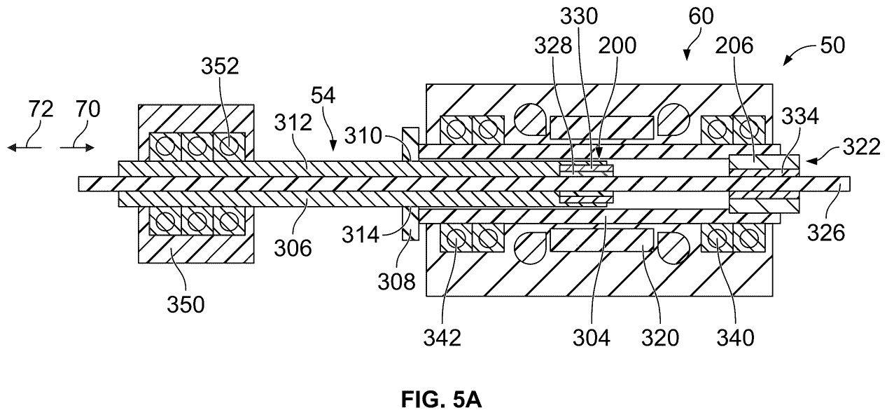

The first head 50 supports the workpiece in a cantilevered manner with a portion of the workpiece projecting from a guide bushing 206 of the first head 50 to be machined by tools of the tool holder assembly 58. The guide bushing 206 slidably supports the workpiece and permits the workpiece to shift axially along the axis of rotation 73 relative to the guide bushing 206. The first drive 60 is configured to shift the workpiece in Z directions 70, 72 to align different portions of the workpiece with the tools of the tool holder system 58. As discussed below with respect to FIG. 5A, the first head 50 includes a tool holder such as collet 200 to secure the workpiece in the first head 50. The collet 200 is shifted in Z direction 70 toward the guide bushing 206 to increase the length of the workpiece projecting from the guide bushing 206. The collet 200 is shifted in Z direction 72 away from the guide bushing 206 to shorten the length of the workpiece projecting from the guide bushing 206.

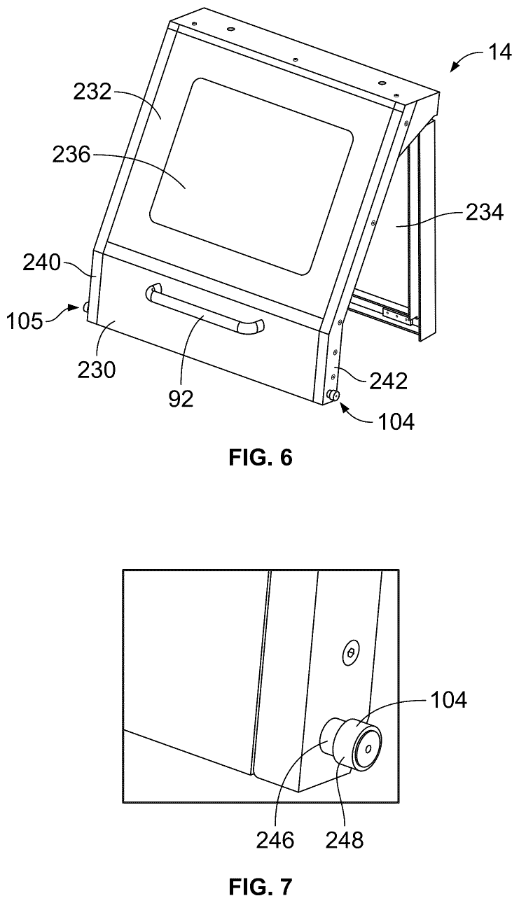

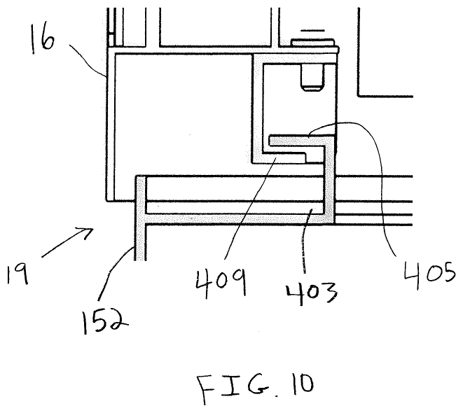

With reference to FIGS. 1 and 2, the machine tool 10 has a guide, such as tracks 100, 102 of the first door frame 20, for directing movement of the door sections 80, 82 of the folding door 14 along a predetermined path as the folding door 14 is moved from the closed to the open position thereof. Regarding FIGS. 6 and 7, the folding door 14 has one or more guide bearings such as rollers 105, 104 that ride in the tracks 100, 102 and contact walls of the tracks 100, 102 to limit movement of the folding door 14 to the predetermined path. The lower end of the door section 80 of the folding door 14 has the rollers 105, 104 to travel along the tracks 100, 102 while the upper end of the door section 80, the hinge 84, and the lower end of the door section 82 may shift outward from the tracks 100, 102 to permit folding of the folding door 14. The machine tool 10 likewise has a guide 19 (see FIG. 2) for directing movement of the sliding door 16, such as tracks that receive rollers of the sliding door 16. With reference to FIG. 10, the guide 19 may include a channel 403 of the lower support frame 152 with a flange 405. The sliding door 16 has a channel 407 that receives the flange 405 and includes a flange 409. The flanges 405, 409 overlap in the vertical direction. The guide 19 may include one or more stops of the sliding door 16 and lower support frame 152 to limit movement of the sliding door 16, such as a surfaces of the sliding door 16 and the lower support frame 152 that abut when the sliding door 16 has been fully opened (see FIG. 3).

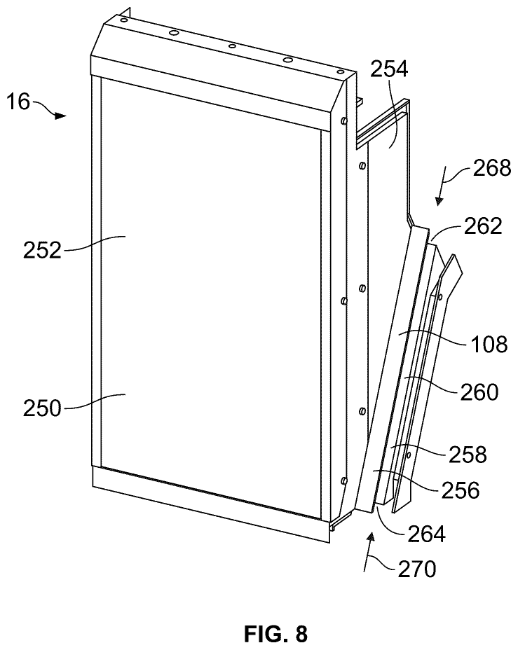

Returning to FIG. 2, the track 100 includes a stationary upper track portion 106, a movable intermediate track portion 108 of the sliding door 16 (see FIG. 8) and a stationary lower track portion 110. The movable intermediate track portion 108 projects from the side of the sliding door 16 adjacent to the folding door 14. The movable intermediate track portion 108 is inclined to guide the folding door 14 as the folding door 14 moves with opening and closing movements of the folding door 14. The upper and lower track portions 106 and 108 have sections thereof that are inclined at the same angle as the track portion 108. Thus, when the folding door 14 and the sliding door 16 are closed, the movable intermediate track portion 108 is aligned with the sections of the stationary upper and lower track portions 106, 110 such that the roller 105 may travel from the stationary lower track portion 110, to and through the movable intermediate track portion 108, and to the stationary upper track portion 106 as the folding door 14 is opened. Conversely, closing the folding door 14 from the open position of FIG. 2 involves the roller 105 traveling from the stationary upper track portion 106, to and through the movable intermediate track portion 108, and to the stationary lower track portion 110. The track 100 may include small gaps between the stationary upper track portion 106, movable intermediate track portion 108, and stationary lower track portion 100 that are traversed by the guide roller 105 as the folding door 14 is opened and closed.

The track 102 includes a stationary upper track portion 120, a stationary intermediate track portion 122, and a stationary lower track portion 124. The roller 104 travels along the stationary upper track portion 120, stationary intermediate track portion 122, and stationary lower track portion 124 as the folding door 14 is moved from the open position of FIG. 2 to the closed position of FIG. 1. The roller 104 travels through the stationary upper track portion 120, stationary intermediate track portion 122, and stationary lower track portion 124 in an opposite order when the folding door 14 is moved from the closed position of FIG. 1 to the open position of FIG. 2.

The track 100 provides a travel path for the folding door 14 as the folding door is opened and closed. The travel path has opposite ends 157, 159. The folding door 14 is fully opened when the guide rollers 104, 105 are at the end 159 of the travel path and the folding door 14 is fully closed when the guide rollers 104, 105 are at the end 157 of the travel path. The stationary upper track portion 120 may include an incline, depression, detent, or other structure to resist unintentional closing of the folding door 14. For example, the friction between the rollers 104, 105 and the track 100 may be sufficient to resist closing movement of the folding door 14.

With the folding door 14 in the open position and the sliding door 16 in the closed position as shown in FIG. 2, the access opening 23 of the frame assembly 18 has a width 132 along the axis 73 (see FIG. 2) of the first and second heads 50, 52. The initial opening 130 further has a height 133 between a raised, lower portion 134 of the folding door 14 and a lateral support beam 138 of the frame assembly 18. The access opening 23 is generally bounded by the side tracks 100, 102 on either side of the access opening 23 and the folding door lower portion 134 and the lateral support beam 138 at the upper and lower sides of the access opening 23.

The folding door 14 is sized to cover the area of the access opening 23 bounded by the upper portion 86 of the frame assembly 18, the tracks 100, 102, and the lateral support beam 138 when the folding door 14 is closed. The sliding door 16 is sized to cover the area of the access opening 23 bounded by upper and lower support frames 150, 152 and a side member 204 (see FIG. 6) of the folding door 14 when the sliding door 16 is closed.

With the folding door 14 and the sliding door 16 in the open positions thereof, the enlarged access opening 25 of the frame assembly 18 is larger than the access opening 23 to provide easier access to the machining area 12 as shown in FIG. 3. More specifically, the frame assembly 18 includes the upper and lower support frames 150, 152 with the stationary upper and lower track portions 106, 110 secured thereto. The enlarged opening 140 has upper and lower areas 154, 155 with the same lateral width 132 as when the sliding door 16 is in the closed position thereof. The enlarged access opening 25 includes an intermediate or central area 156 having a lateral width 158 between the stationary intermediate track portion 122 and the movable intermediate track portion 108 that is larger than the width 132. The central area 156 is larger in part because the movable intermediate track portion 108 is moved out of the way by opening the sliding door 16.

With the sliding door 16 in the open position, the movable intermediate track portion 108 is shifted horizontally in the lateral direction away from the access opening 23 and from the stationary upper and lower track portions 106, 110 such that there is an opening extension distance 160 between the movable intermediate track portion 108 and the stationary upper and lower track portions 106, 110 in the lateral direction corresponds to the width of the opening extension distance 160. The opening extension distance 160 and the wider intermediate portion 156 of the enlarged opening 140 forms a window opening 170 between the upper and lower support frames 150, 152 and the movable intermediate track portion 108 once the sliding door 16 has been shifted out of the way to the open position. The window opening 170 provides extra space for a user to position themselves closer to the machine tool components for leaning into the machining area 12 and accessing the first head 50 and tool holder system 58, such as to load/unload a workpiece, load/unload tools, and adjust the tool holders of the tool holder system 58.

The window opening 170 has a height 171 between the upper and lower frames 150, 152. The window height 171 may be less than the height 133 of the enlarged access opening 25 but sufficiently large enough to provide space for the operator's arm and/or shoulder to extend into the machining area 12 through the window opening 170. Further, the operator may lean into the machining area 12 with the operator's head in the upper area 154 of the opening 25 to visually observe the first head 50 and/or tool holder system 58 as the operator manually loads/unloads workpieces or tools. The ability of the operator to put their torso including their arm and/or shoulder through the window opening 170 and their head in the upper area 154 of the opening 25 permits the operator to access the first head 50 and tool holder system 58 with improved ergonomic body positioning so that the operator has a more comfortable body positioning than if the operator were to position their body in the machining area 12 around the sliding door 16 in the closed position thereof.

With reference to FIG. 2, the machine tool 10 includes an actuator 173, such as a powered linear actuator, to shift the sliding door 16 between closed and open positions. The sliding door 16 may instead or additionally be manually shifted by the operator. Although the second door of the machine tool 10 is illustrated as sliding door 16, in other embodiments different movements of the second door of the machine tool 10 may be utilized. For example, the second door of the machine tool may pivot rather than slide to open the window 170. The actuator 173 may include an electric motor and a transmission to pivot the second door, and/or the second door may be manually pivoted between closed and open positions, as some examples.

Referring to FIG. 5A, a schematic view of the first head 50 is provided. The head 50 includes the first spindle 54 with a spindle shaft 304 and a spline shaft 306. The first spindle 54 includes a spline adapter 308 fixed to the spindle shaft 304 such as by fasteners. The spline adapter 308 has an opening 314 through which the spline shaft 306 extends. The spline adapter 308 has female splines 310 that engage male splines 312 of the spline shaft 306. The engagement between the female splines 310 and the male splines 312 permits the spline shaft 306 to shift axially relative to the spindle shaft 304 in an axially inward, retracting Z direction 72 and in an axially outward, extending Z direction 70. The engagement between the female splines 310 and male splines 312 inhibits relative rotary movement of the spline shaft 306 and the adapter 308. The first head 50 includes the first drive 60. The first drive 60 has a motor 320 connected to the spindle shaft 304 such as by having a rotor of the motor 320 shrink-fit onto the spindle shaft 304. The motor 320 turns the spindle shaft 304 which turns the spline shaft 306 via the spline adapter 308.

The guide bushing 206 is mounted to the spindle shaft 304 and is rotatable therewith. The guide bushing 206 cooperates with the collet 200 to support a workpiece 326. The collet 200 includes a collet adapter 328 that engages a radially inner surface of the spline shaft 306 and a collet body 330 that engages the workpiece 326. The guide bushing 206 similarly includes a guide bushing adapter 332 and a work holder such as a guide collet 334. The collet 200 is fixed relative to the workpiece 326 in axial and rotary directions whereas the guide collet 334 permits axial shifting of the workpiece 326 relative to the guide bushing 206. The head 300 includes bearings 340, 342 that support the spindle shaft 304 and a support assembly 350 that is axially shiftable in directions 72, 70 to shift the spline shaft 306 and workpiece 326 secured thereto in axial directions 72, 70. The support assembly 350 has bearings 352 to permit rotation of the spline shaft 306.

With reference to FIG. 5B, the tool holder system 58 includes a first tool holder array, such as first tool holder assembly 210, having one or more tool holders for machining a workpiece held by the first head 50. The tool holder system 58 further includes a second tool holder array, such as second tool holder assembly 212, having one or more tool holders to machine a workpiece held by the second head 52. For example, the first tool holder assembly 210 includes tool holders 214A, 214B, 214C, 214D, 214E, and 214F for machining a workpiece held by the first head 50. The second tool holder assembly 212 includes tools 216A, 216B, 216C, 216D for machining a workpiece held by the second head 52. As indicated in FIG. 5B, the first head 50, second head 52, and tool holder system 58 are operable to move the workpiece(s) and tools about axes X1, X2, Y1, Y2, Z1, Z2, Bl, C1, C2. Each tool holder receives a tool and retains the tool using a mechanism appropriate for the tool. For example, the tool holders 214B each have a channel that receives a tool and a clamp block that is tightened down to fix the tool in the channel. By contrast, the tool holders 214D, 216A may each include a collet to secure a bit in the tool holder.

With reference to FIG. 6, the door sections 80, 82 of the folding door 14 include one or more body panels to extend across the access opening of the machine tool 10. In one embodiment, the door section 80 includes door body panels 230, 232 that are fixed together and the door section 82 includes door body panel 234. The door body panel 232 has a transparent portion such as a window 236. The folding door 14 has side members 240, 242 that fix the door body panels 230, 232 together and support pins 246 (see FIG. 7) to which the rollers 104, 105 are rotatably mounted. The rollers 104, 105 have cylindrical surfaces 248 that roll along the tracks 100, 102.

With reference to FIG. 8, the sliding door 16 includes a body 250 having a panel portion 252 for covering the window opening 170 when the sliding door 16 is in a closed position and a flange portion 254 for supporting the movable intermediate track portion 108. The movable intermediate track portion includes a roller channel 260 having guide portions such as wall portions 256, 258 along which the roller 105 may travel and an opening therebetween sized to receive the roller 105. The movable intermediate track portion has an upper end 262 and a lower end 264. The roller 105 enters the channel upper end 262 in direction 268 as the folding door 14 is moved from the open position to the closed position. Conversely, the roller 105 enters the channel lower end 264 in direction 270 as the folding door 14 goes from the closed position to the open position. In this manner, the movable intermediate track portion 108 may guide the folding door 14 along a predetermined path when the sliding door 16 is in the closed position, while being out of the way of a user leaning into the machining area 12 once the sliding door 16 has been moved to the open position.

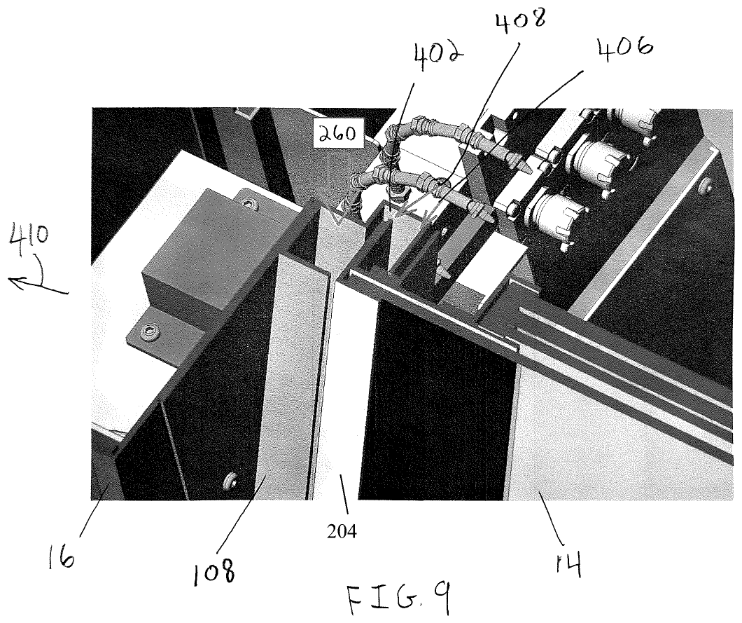

With reference to FIGS. 8 and 9, the folding door 14 and the sliding door 16 have an interface 400 therebetween that inhibits opening of the sliding door 16 when the folding door 14 is closed. More specifically, the movable intermediate track portion 108 includes a retainer channel 402 next to the roller channel 206. The retainer channel 402 includes a stop member, such as retainer flange 406, that overlaps with a stop member, such as flange 408, of the side member 240 of the folding door 14 when the folding door 14 is closed. If the operator attempts to open the sliding door 16 in direction 410 when the folding door 14 is closed, the flange 406 will contact the flange 408 and inhibit the operator from opening the sliding door 16. Once the user opens the folding door 14, the flange 408 is up and out of the way of the flange 406 such that the sliding door 16 may be opened in direction 410 without interference between the flanges 406, 408.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A machine tool comprising:
a frame assembly;
a first head having a first rotatable workpiece holder;
a second head having a second rotatable workpiece holder;
a first door of the frame assembly movable in a first direction between a first closed position and a first open position;
a second door of the frame assembly movable in a second direction transverse to the first direction between a second closed position and a second open position;
the frame assembly having an access opening sized to be closed by the first door in the first closed position and to permit access to the first and second heads with the first door in the first open position and the second door in the second closed position; and
the frame assembly having a larger access opening sized to be closed by the first door in the first closed position and the second door in the second closed position and to increase ease of user accessibility to the first and second heads with the first door in the first open position and the second door in the second open position.

2. The machine tool of claim 1 wherein the first door includes pivotally connected door sections configured to pivot relative to one another as the first door moves between the first closed position and the first open position.

3. The machine tool of claim 1 wherein the first head is configured to rotate the first rotatable workpiece holder around an axis;
wherein the access opening of the frame assembly has a first maximum width along the axis with the first door in the first open position and the second door in the first closed position; and
wherein the enlarged access opening of the frame assembly has a second maximum width along the axis with the first door in the first open position and the second door in the second open position, the second maximum width being larger than the first maximum width.

4. The machine tool of claim 3 wherein the access opening of the frame assembly has a first maximum height perpendicular to the first maximum width; and
wherein the enlarged access opening of the frame assembly has a second maximum height perpendicular to the second maximum width, the second maximum height being the same as the first maximum height.

5. The machine tool of claim 3 wherein the second door is movable from the second closed position to the second open position in a direction parallel to the axis.

6. The machine tool of claim 1 wherein the first door is movable along a predetermined path from the first closed position to the first open position, the first door moving in the first direction in a first portion of the predetermined path and moving in a third direction in a second portion of the predetermined path, the third direction being transverse to the first direction.

7. The machine tool of claim 1 wherein the second door is linearly shiftable between the second closed position and the second open position.

8. The machine tool of claim 1 wherein the first door is a first sliding door and wherein the second door is a second sliding door.

9. The machine tool of claim 1 where the first sliding door includes pivotally connected door sections that pivot relative to each other.

10. The machine tool of claim 1 wherein the frame assembly includes a track, and the first door includes a guide bearing engaged with the track, the guide bearing movable along the track as the first door moves between the first closed position and the first open position, and
wherein the second door includes at least a section of the track that is movable with the second door as the second door moves between the second closed position and the second open position.

11. The machine tool of claim 1 wherein the movement of the first door in the first direction comprises movement upwardly and rearwardly and the movement of the second door in the second direction comprises movement of the second door laterally.

12. A machine tool comprising:
a head to rotate a workpiece;
tool holders configured to receive tools for machining the workpiece;
a first door movable between a first closed position wherein the first door obstructs access to the head and the tool holders and a first open position wherein the first door permits access to the head and the tool holders; and
a second door movable between a second closed position and a second open position when the first door is in the first open position to increase access to the head and tool holders, the second door not being movable between the second closed position and the second open position when the first door is in the first closed position.

13. The machine tool of claim 12 wherein the first door is movable between the first closed position and the first open position in a first direction; and
wherein the second door is movable between the second closed position and the second open position in a second direction transverse to the first direction.

14. The machine tool of claim 12 wherein the first and second doors include stop members having an interference configuration with the first door in the first closed position and the second door in the second closed position, the stop members in the interference configuration being positioned to contact one another and inhibit movement of the second door from the second closed position to the second open position; and
wherein the stop members have a clearance configuration with the first door in the first open position and the second door in the second closed position, the stop members in the clearance configuration being spaced from one another to permit movement of the second door from the second closed position to the second open position.

15. The machine tool of claim 12 further comprising a track for the first door;
wherein the first door includes a guide bearing configured to move along the track as the first door moves between the first closed position and the first open position; and
wherein the second door includes at least a portion of the track so that the track portion and the second door move together between the second closed position and the second open position.

16. The machine tool of claim 15 wherein the track includes a stationary portion of the track that is fixed to the frame assembly;
wherein the portion of the track of the second door is aligned with the stationary portion of the track when the second door is in the second closed position to permit the guide bearing of the first door to travel along the aligned portion of the track as the first door moves between the first closed position and the first open position.

17. The machine tool of claim 12 further comprising a track having a stationary upper portion, a stationary lower portion, and a movable intermediate portion between the stationary upper and lower portions;
wherein the first door includes a guide bearing configured to travel along the track as the first door moves between the first closed position and the first open position;
wherein the second door includes the movable intermediate portion of the track, the movable intermediate portion of the track being operatively positioned with the second door in the second closed position to permit the guide bearing to travel along the stationary upper portion, stationary lower portion, and movable intermediate portion of the track as the first door moves between the first closed position and the first open position.

18. The machine tool of claim 12 further comprising a track having a channel;
wherein the first door has a guide bearing configured to travel in the channel; and
wherein the second door includes at least a portion of the track such that the guide bearing of the first door travels in a portion of the channel of the track portion of the second door as the first door moves between the second closed position and the second open position.

19. The machine tool of claim 12 wherein the first door includes door sections and a hinge between the door sections that permits an angle between the door portions to change as the first door is moved between the first closed position and the first open position.

20. The machine tool of claim 19 wherein the second door shifts along a linear path between the second closed position and the second open position.

21. The machine tool of claim 12 wherein the head includes a guide bushing and a workpiece holder shiftable relative to the guide bushing along an axis; and
wherein the second door is farther from the guide bushing with the second door in the second open position than when the second door is in the second closed position.

22. The machine tool of claim 12 wherein the head is operable to rotate the workpiece around an axis;
wherein the tool holders include at least one tool holder intermediate the axis and the second door in a radial direction with the second door in the second closed position; and
wherein the second door is spaced from the at least one tool holder along the axis with the second door in the second open position to permit user access to the at least one tool holder.

23. The machine tool of claim 12 wherein the second door includes a track section and the first door includes a guide bearing for engaging the track section as the first door is moved between first closed and first open positions; and
wherein the bearing of the first door is disengaged from the track section of the second door with the first door in the first open position.

24. The machine tool of claim 12 wherein the first door is movable along a travel path having spaced ends thereof, and the first open position is at one of the ends where the first door is fully open and the first closed position is at the other end where the first door is fully closed.

25. A method for operating a machine tool, the method comprising:
opening a first door of the machine tool in a first direction to form an access opening that permits access to a head and tool holders of the machine tool, the head configured to rotate a workpiece and the tool holders configured to receive tools to machine the workpiece; and
opening a second door of the machine tool in a second direction transverse to the first direction to enlarge the access opening and increase access to the head and the tool holders.

26. The method of claim 25 wherein the second direction is orthogonal to the first direction.

27. The method of claim 25 wherein opening the first door includes pivoting portions of the first door relative to one another.

28. The method of claim 27 wherein opening the second door includes sliding the second door in the second direction.

29. The method of claim 25 wherein opening the first door comprises shifting a bearing of the first door along a track of the second door.

30. The method of claim 29 wherein opening the second door comprises moving the track of the second door.

31. The method of claim 25 wherein opening the first door comprises moving a guide bearing of the first door along a track including aligned stationary upper and lower track sections of the machine tool and a movable intermediate track section of the second door; and
wherein opening the second door comprises moving the intermediate track section of the second door out of alignment with the stationary upper and lower track sections.

32. Doors for closing a machining area of a machine tool, the doors comprising:
a first door having pivotally connected door sections;
a second door;
the first and second doors having a closed configuration wherein the first and second doors are closed and inhibit access to the machining area;
the first and second doors having a partially open configuration wherein the first door is open and the second door is closed, the first and second doors in the partially open configuration permitting access to the machining area; and
the first and second doors having a fully open configuration wherein the first door is open and the second door is open, the first and second doors in the fully open configuration permitting increased access to the machining area than when the first and second doors are in the partially open configuration.

33. The doors of claim 32 wherein the first and second doors have overlapping portions configured to inhibit opening of the second door with the first and second doors in the closed configuration.

34. The doors of claim 33 wherein the overlapping portions of the first and second doors are offset from one another with the first and second doors in the partially open configuration to permit opening of the second door.

35. The doors of claim 32 wherein the second door includes a track; and
wherein the first door includes a guide bearing configured to travel along the track as the first and second doors are shifted between the closed and partially open configurations.

36. The doors of claim 32 wherein the first and second door include a track section and a guide roller to travel therealong, the track section and guide roller configured so that the guide roller travels onto and off of the track section as the first and second doors are shifted between the partially open configuration and the fully open configuration.

37. The doors of claim 32 wherein the first door is movable in a first direction as the first and second doors are shifted from the closed configuration to the partially open configuration; and
wherein the second door is movable in a second direction transverse to the first direction as the first and second doors are shifted from the partially open configuration to the fully open configuration.

38. The doors of claim 32 wherein the first and second doors are sliding doors.

39. The doors of claim 32 wherein the first door includes a hinge for pivotally connecting the first door to a frame assembly of the machine tool.
